(19) United States
(12) Patent Application Publication
(10) Pub. No.: US 2015/0115817 A1
(43) Pub. Date: Apr. 30, 2015

(54) CONSTRUCTION IMPROVEMENT OF LED LIGHT SET

(71) Applicant: YAU-CHIN PENG, Hsinchu City (TW)

(72) Inventor: YAU-CHIN PENG, Hsinchu City (TW)

(21) Appl. No.: 14/065,373

(22) Filed: Oct. 28, 2013

(51) Int. Cl. H05B 33/08

(52) U.S. Cl. CPC H05B 33/0821
USPC 315/192

(57) ABSTRACT

The present invention provides construction improvement of LED light set mainly including a controller connected with an electricity plug and a main light string of a plurality of main light bulbs in serial arrangement while each of the main light bulbs is individually connected with an associate light string of a plurality of associate light bulbs as characterized in that a main control IC is provided within the controller to control the main light string operation and an associate control IC is provided within each main light bulb to control the associate light string operation. Thereby the capability of the associate control IC within each main light bulb to reduce both voltage and current is utilized to enable every associate light string to use an associate conducting wire thinner than a main conducting wire in order to reduce the manufacturing cost significantly.

### TECHNICAL FIELD OF THE INVENTION

The present invention is related to a technical improvement of LED light set commodity, particularly to a technical improvement on the construction of control and conducting wire of a LED light set.

### DESCRIPTION OF THE PRIOR ART

The present invention is related to an improvement of a LED light set having both main and associate light strings. FIG. 1 depicts a schematic diagram of the LED light set of the prior art that mainly includes a controller (10), which is provided with an electricity plug (11) and a main control IC (12), connected with a main light string (20), which is composed of a main conducting wire (23) and a plurality of main light bulbs (21) in serial arrangement, while each main light bulb (21) is individually connected with an associate light string (30), which is composed of an associate conducting wire (32) and a plurality of associate light bulbs (31) in serial arrangement, such that every associate light string is parallel to each other. The operation of the LED light set is that, after the electricity plug (11) is connected to an electricity source, the voltage, current and flashing mode of all LED light bulbs of both the main light string (20) and associate light string (30) are only controlled by the main control IC (12) within the controller (10). Therefore both the main light string (20) and associate LED light string (30) are operating at the same voltage and current and thus the main conducting wire (23) and all associate conducting wire (32) are made of the same gage. However the quantity of the associate conducting wire (32) is so significantly big that the cost of conducting wires is relatively high and consequently the manufacturing cost of the LED light set is also high. Hence the construction of the prior art has rendered the necessity for improvement.

### SUMMARY OF THE INVENTION

An objective of the present invention, a construction improvement of LED light set, is to provide a main control IC within a controller for controlling the operation of a main light string and an associate control IC within each main light bulb for controlling the operation of an associate light string. Thereby the capability of the associate control IC within each main light bulb to adjust both voltage and current is so utilized to enable every associate light string to use an associate conducting wire thinner than a main conducting wire in order to significantly reduce the manufacturing cost.

### BRIEF DESCRIPTION OF THE DRAWINGS

FIG. 1 is a schematic diagram illustrating the construction of a LED light set of the prior art.

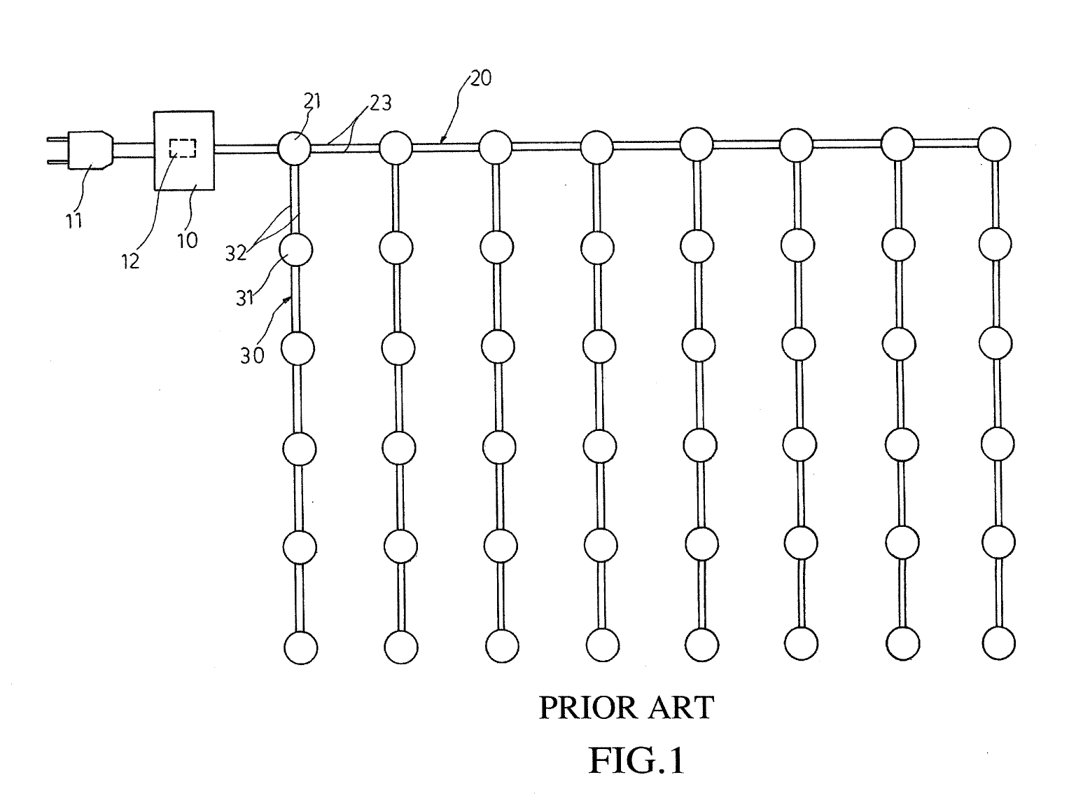

FIG. 2 is a schematic diagram illustrating the embodiment for a construction improvement of a LED light set of the present invention.

### DETAILED DESCRIPTION OF THE PREFERRED EMBODIMENTS

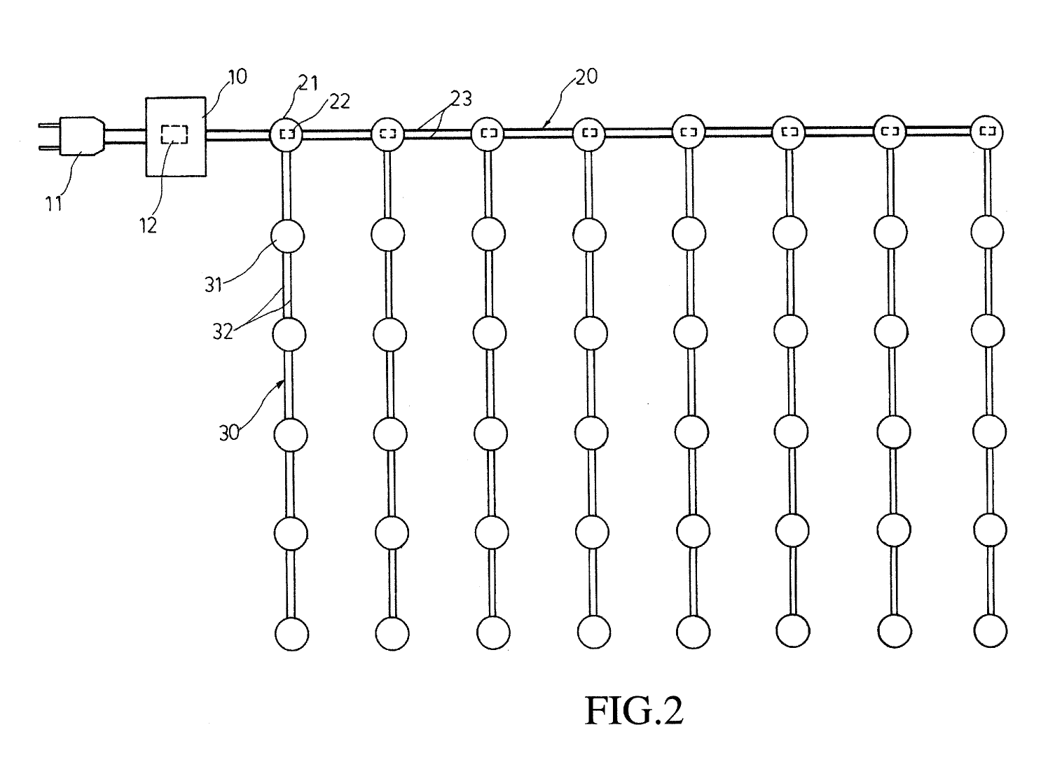

Please refer FIG. 2, an embodiment for construction improvement of a LED light set of the present invention that mainly includes a controller (10) having one end connected to an electricity plug (11) and the other end connected to a main LED light string (20), which is composed of a main conducting wire (23) and a plurality of main light bulbs (21) in serial arrangement, while each main light bulb (21) is individually connected with an associate light string (30), which is composed of an associate conducting wire (32) and a plurality of associate light bulbs (31) in serial arrangement so that every associate light string (30) is in parallel to each other. The embodiment of the present invention is characterized in that a main control IC (12) is provided within the controller (10) while an associate control IC (22) is provided within each main light bulb (21) of the main LED light string (20) so as to control the voltage, current and flashing mode of all main light bulb (21) by the main control IC (12) within the controller (10) and the voltage, current and flashing mode of all associate light bulbs (31) of the associate light string (30) by the associate control IC (22) within each main light bulb (21) whereby the associate control IC (22) within each main light bulb (21) is capable of adjusting both voltage and current for reducing the voltage into each associate light string (30) to an operational voltage relatively lower than the voltage of the main LED light string (20). Therefore the associate conducting wire (32) of each associate light string (30) can be relatively thinner than the main conducting wire (23). Thereby the capability of the associate control IC (22) within each main light bulb (21) to adjust both voltage and current is utilized to enable every associate light string (30) to use the associate conducting wire (32) thinner than the main conducting wire (23). Therefore the manufacturing cost of the associate conducting wire (32) is significantly reduced due to the relatively large quantity of the associate light strings (30) and consequently the total manufacturing cost of the LED light set is also significantly reduced.

I claim:

1. A construction improvement of a LED light set comprising a controller with a first end connected to an electricity plug and a second end connected to a main light string, the main light string composed of a main conducting wire and a plurality of main light bulbs in serial arrangement while each main light bulb individually connected with an associate light string, each of the associate light strings composed of an associate conducting wire and a plurality of associate light bulbs in serial arrangement such that every associate light string in parallel to each other, is characterized in that a main control IC provided within the controller while an associate control IC provided within each main light bulb so as to control the voltage, current and flashing mode of all main light bulbs of the main light string by said main control IC within the controller and the voltage, current and flashing mode of each associate light bulbs individually by said associate control IC within each main light bulb whereby said associate control IC within each main light bulb is capable of adjusting both voltage and current for reducing the voltage into each associate light string to an operational voltage so relatively lower than the voltage of the main light string that the associate conducting wire of each associate light string can be relatively thinner than the main conducting wire of the main light string.
